(19) United States
(12) Patent Application Publication
(10) Pub. No.: US 2026/0124091 A1
(43) Pub. Date: May 7, 2026

(54) MASSAGE APPARATUS

(71) Applicant: Menglong CHEN, Fuan City (CN)

(72) Inventor: Menglong CHEN, Fuan City (CN)

(21) Appl. No.: 19/438,654

(22) Filed: Jan. 2, 2026

(51) Int. Cl. A61H 1/02; A47C 1/032; A47C 7/50; A61H 7/00

(52) U.S. Cl. CPC A61H 1/0214; A47C 1/032; A47C 7/5068; A61H 7/004; A61H 2201/0149; A61H 2201/0188; A61H 2201/0192; A61H 2201/1215; A61H 2201/1623; A61H 2201/164; A61H 2201/1671; A61H 2201/1676; A61H 2201/1692; A61H 2203/0431; A61H 2203/0437; A61H 2205/081; A61H 2205/10; A61H 2205/12

(57) ABSTRACT

A massage apparatus, including: a backrest frame; and a seat cushion frame, which is connected to a bottom of the backrest frame; and a supporting frame, the seat cushion frame is rotatably connected to an upper portion of the supporting frame; and a leg-foot assembly, comprises a first leg-foot frame and a second leg-foot frame, the first leg-foot frame and the second leg-foot frame are each rotatably connected to a front end of the seat cushion frame; and a driving mechanism, configured to drive the backrest frame and the seat cushion frame to rotate relative to the supporting frame so as to switch the massage apparatus between a first massage state and a second massage state, the driving mechanism is further configured to drive the first leg-foot frame and the second leg-foot frame to rotate relative to the seat cushion frame.

### TECHNICAL FIELD

The present disclosure relates to the technical field of massage equipment, in particular to a massage apparatus having a leg interactive motion massage portion.

### BACKGROUND

Massage chairs, as a common massage apparatus in daily life, can provide users with relaxing and comfortable massage services. Massage chairs typically offer massage modes such as back massage and limb massage, which can effectively alleviate muscle fatigue in users, promote blood circulation, and meet diversified health needs of users.

Currently, the massage functions of existing massage chairs on the market primarily focus on back massage and leg massage. Even though massage chairs allow cyclic switching between sitting and reclining postures, the provided massage actions remain relatively monotonous. For leg massage, existing leg massage assemblies generally adopt an integrated dual-leg design, capable only of providing synchronous lifting or lowering massage actions for both legs. For massage modes requiring independent left and right leg massage, existing massage chairs cannot satisfy personalized massage demands. Moreover, in corresponding leg massage assemblies, the massage trajectory of the integrated massage head assembly is fixed, allowing massage only in predetermined leg regions. The massage heads cannot move during massage, resulting in limited massage areas, monotonous massage effects, and compromised user experience.

To address this, the present disclosure provides a massage apparatus capable of effectively solving the aforementioned problems, with a simple structure and rich functions, thereby satisfying diversified massage needs.

### SUMMARY

In order to overcome the deficiencies of the prior art, the present disclosure provides a massage apparatus having a simple structure and rich functions, capable of satisfying diversified massage needs.

To realize the above objective, the present disclosure provides a massage apparatus, including: a backrest frame; and a seat cushion frame connected to a bottom of the backrest frame; and a supporting frame, the seat cushion frame is rotatably connected to an upper portion of the supporting frame; and a leg-foot assembly, comprises a first leg-foot frame and a second leg-foot frame, the first leg-foot frame and the second leg-foot frame are each rotatably connected to a front end of the seat cushion frame; and a driving mechanism, configured to drive the backrest frame and the seat cushion frame to rotate relative to the supporting frame so as to switch the massage apparatus between a first massage state and a second massage state, the driving mechanism is further configured to drive the first leg-foot frame and the second leg-foot frame to rotate relative to the seat cushion frame.

The advantageous effects of the massage apparatus of the present disclosure are as follows: through the arrangement of the above structure, the rear end of the seat cushion frame is connected to the bottom end of the backrest frame, and the seat cushion frame is rotatably connected to the supporting frame, such that the driving mechanism can drive the seat cushion frame to rotate relative to the supporting frame, thereby synchronously driving the backrest frame to rotate. This allows the massage apparatus to switch between a first massage state (sitting posture state) and a second massage state (reclining posture state). The leg massage frame comprises a first leg-foot frame and a second leg-foot frame arranged side by side at the front end of the seat cushion frame. The driving mechanism can independently or simultaneously drive the first leg-foot frame and the second leg-foot frame to lift or lower, enabling them to rotate relative to the front end of the seat cushion frame, thereby providing the user with a massage action similar to “pedaling a bicycle,” which can alleviate muscle fatigue in the user's legs.

### BRIEF DESCRIPTION OF DRAWINGS

To illustrate the technical solutions in the embodiments of the present disclosure more clearly, the drawings used in the description of the embodiments will be briefly introduced below. The drawings described below merely represent some embodiments of the present disclosure. For those of ordinary skill in the art, other drawings may be obtained based on these drawings without creative effort.

The present disclosure will be further described below in conjunction with the drawings and embodiments.

FIG. 1 is a schematic structural diagram of an overall structure of a massage apparatus according to an embodiment of the present disclosure.

FIG. 2 is a partial schematic structural diagram of the massage apparatus according to an embodiment of the present disclosure from one perspective (omitting a leg-foot massage mechanism and a light-shielding assembly).

FIG. 3 is a partial schematic structural diagram of the massage apparatus according to an embodiment of the present disclosure from another perspective (omitting the leg-foot massage mechanism and the light-shielding assembly).

FIG. 4 is a partial exploded view of the massage apparatus according to an embodiment of the present disclosure from one perspective (omitting the leg-foot massage mechanism and the light-shielding assembly).

FIG. 5 is a partial exploded view of the massage apparatus according to an embodiment of the present disclosure from another perspective (omitting the leg-foot massage mechanism and the light-shielding assembly).

FIG. 6 is a side view of the massage apparatus according to an embodiment of the present disclosure in a first massage state (omitting the leg-foot massage mechanism and the light-shielding assembly).

FIG. 7 is a side view of the massage apparatus according to an embodiment of the present disclosure in a second massage state (omitting the leg-foot massage mechanism and the light-shielding assembly).

FIG. 8 is a top view of the massage apparatus according to an embodiment of the present disclosure in the second massage state (omitting the leg-foot massage mechanism and the light-shielding assembly).

FIG. 9 is an enlarged view of an area A in FIG. 8.

FIG. 10 is a side view of the massage apparatus according to an embodiment of the present disclosure with the slide plate positioned at a front end of the supporting frame (omitting the leg-foot massage mechanism and the light-shielding assembly).

FIG. 11 is a top view of the massage apparatus according to an embodiment of the present disclosure with the slide plate positioned at the front end of the supporting frame (omitting the leg-foot massage mechanism and the light-shielding assembly).

FIG. 12 is an enlarged view of an area B in FIG. 11.

FIG. 13 is a partial schematic structural diagram of the leg-foot massage mechanism from one perspective according to an embodiment of the present disclosure.

FIG. 14 is a partial schematic structural diagram of the leg-foot massage mechanism from another perspective according to an embodiment of the present disclosure.

FIG. 15 is a partial exploded view of the leg-foot massage mechanism from one perspective according to an embodiment of the present disclosure.

FIG. 16 is a partial exploded view of the leg-foot massage mechanism from another perspective according to an embodiment of the present disclosure.

FIG. 17 is a partial side view of the leg-foot massage mechanism according to an embodiment of the present disclosure.

FIG. 18 is a partial side view in which the first lifting frame of the leg-foot massage mechanism slides along the guiding rail bracket according to an embodiment of the present disclosure.

FIG. 19 is a partial side view in which the second lifting frame of the leg-foot massage mechanism slides along the first lifting frame according to an embodiment of the present disclosure.

FIG. 20 is a partial schematic structural diagram of the first light-shielding state according to an embodiment of the present disclosure (omitting the leg-foot massage mechanism).

FIG. 21 is a partial schematic structural diagram of the second light-shielding state according to an embodiment of the present disclosure (omitting the leg-foot massage mechanism).

FIG. 22 is an exploded view of the light-shielding assembly according to an embodiment of the present disclosure.

FIG. 23 is an exploded view of the mounting component according to an embodiment of the present disclosure.

### DESCRIPTION OF THE REFERENCE NUMERAL

100 backrest frame, 200 seat cushion frame, 210 track, 300 supporting frame, 310 sliding rail, 400 leg-foot frame, 410 first leg-foot frame, 420 second leg-foot frame, 431 rotating shaft, 432 rotating seat, 441 guiding rail bracket, 442 moving bracket, 500 driving mechanism, 510 leg driving assembly, 511 first supporting rod, 512 second supporting rod, 513 swing rod, 514 slide plate, 5141 sliding groove, 515 first driving motor, 516 second driving motor, 520 main driving assembly, 600 light-shielding assembly, 610 light shield, 620 mounting component, 621 first mounting portion, 622 second mounting portion, 623 third mounting portion, 700 leg-foot massage mechanism, 710 first nut, 720 first lifting frame, 721 first lead screw, 722 first leg motor, 723 base, 724 side stand, 725 second lead screw, 726 second leg motor, 727 guiding groove, 730 second lifting frame, 731 second nut, 732 guiding rod, 733 lifting seat, 734 mounting frame, 740 leg massage assembly, 741 leg massage head, 742 leg massage motor, 750 foot massage assembly, 751 foot massage head, 752 foot massage motor.

### DETAILED DESCRIPTION OF THE EMBODIMENTS

To make the objects, features, and advantages of the present disclosure more obvious and understandable, specific embodiments of the present disclosure will be described in detail below with reference to the accompanying drawings. Numerous specific details are set forth in the following description to facilitate a full understanding of the present disclosure. However, the present disclosure can be implemented in many other ways different from those described herein, and those skilled in the art can make similar improvements without departing from the spirit of the present disclosure. Therefore, the present disclosure is not limited by the specific embodiments disclosed below.

In the description of the present disclosure, it should be understood that terms such as “center,” “longitudinal,” “transverse,” “length,” “width,” “thickness,” “upper,” “lower,” “front.” “rear,” “left,” “right,” “vertical,” “horizontal,” “top,” “bottom,” “inner,” “outer,” “clockwise.” “counterclockwise,” “axial,” “radial,” and “circumferential” indicate orientations or positional relationships based on the orientations or positional relationships shown in the drawings. These terms are used merely for convenience in describing the present disclosure and simplifying the description, and do not indicate or imply that the referred device or element must have a specific orientation, be constructed and operated in a specific orientation, and thus should not be construed as limiting the present disclosure.

Furthermore, terms such as “first” and “second” are used for descriptive purposes only and should not be construed as indicating or implying relative importance or implicitly specifying the number of indicated technical features. Thus, features defined with “first” or “second” may explicitly or implicitly include at least one such feature. In the description of the present disclosure, “plurality” means at least two, such as two, three, etc., unless otherwise explicitly and specifically defined.

In the present disclosure, unless otherwise explicitly specified and limited, terms such as “mounted,” “connected,” “coupled,” and “fixed” should be construed broadly. For example, it may be a fixed connection, a detachable connection, or an integral formation; it may be a mechanical connection or an electrical connection; it may be a direct connection or an indirect connection through an intermediary; it may be an internal communication between two elements or an interaction relationship between two elements, unless otherwise explicitly defined. For those of ordinary skill in the art, the specific meanings of the above terms in the present disclosure can be understood according to specific circumstances.

In the present disclosure, unless otherwise explicitly specified and limited, a description such as a first feature being “on” or “under” a second feature may mean that the first and second features are in direct contact, or that the first and second features are in indirect contact through an intermediary. Moreover, the first feature being “above,” “over,” or “on top of” the second feature may mean that the first feature is directly above or obliquely above the second feature, or simply that the horizontal height of the first feature is greater than that of the second feature. The first feature being “below,” “under,” or “beneath” the second feature may mean that the first feature is directly below or obliquely below the second feature, or simply that the horizontal height of the first feature is less than that of the second feature.

It should be noted that when an element is referred to as being “fixed to” or “disposed on” another element, it may be directly on the other element or there may be an intervening element. When an element is considered to be “connected” to another element, it may be directly connected to the other element or there may be an intervening element simultaneously. The terms “vertical,” “horizontal,” “upper,” “lower,” “left,” “right,” and similar expressions used herein are for illustrative purposes only and do not represent the only embodiment.

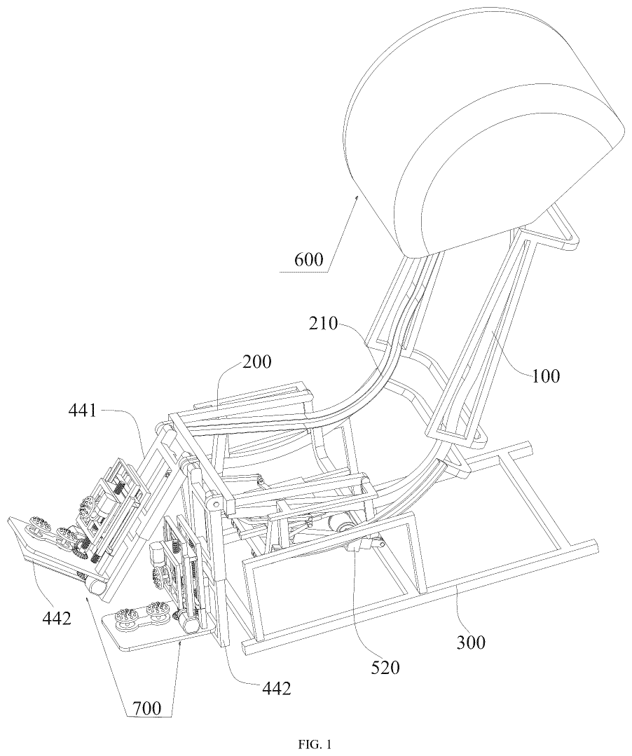

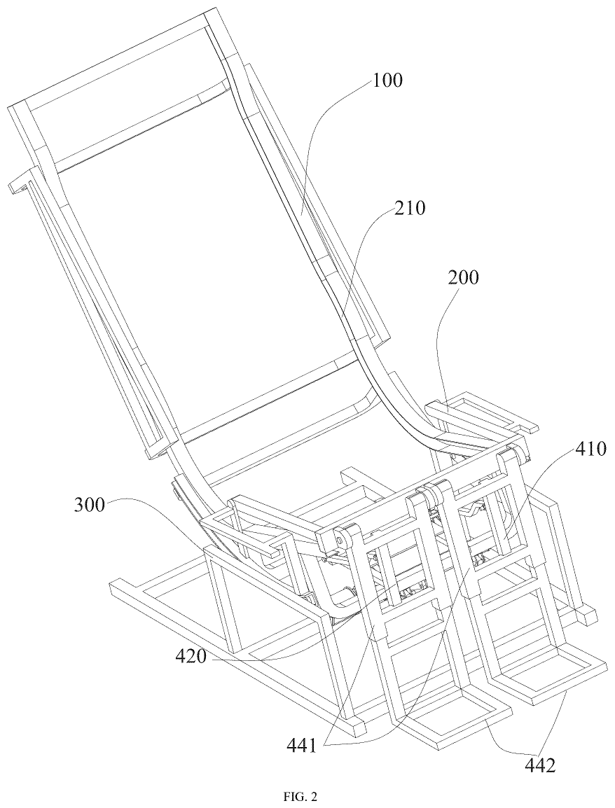

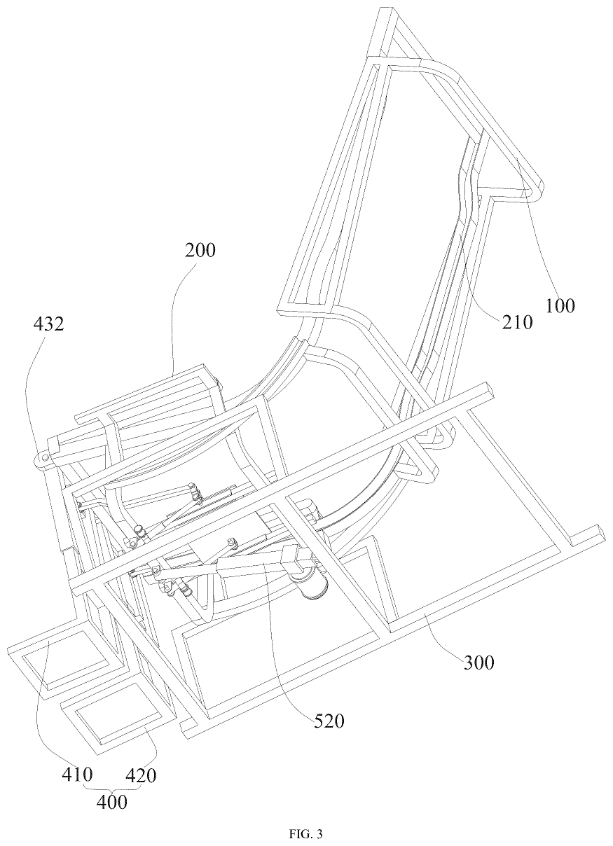

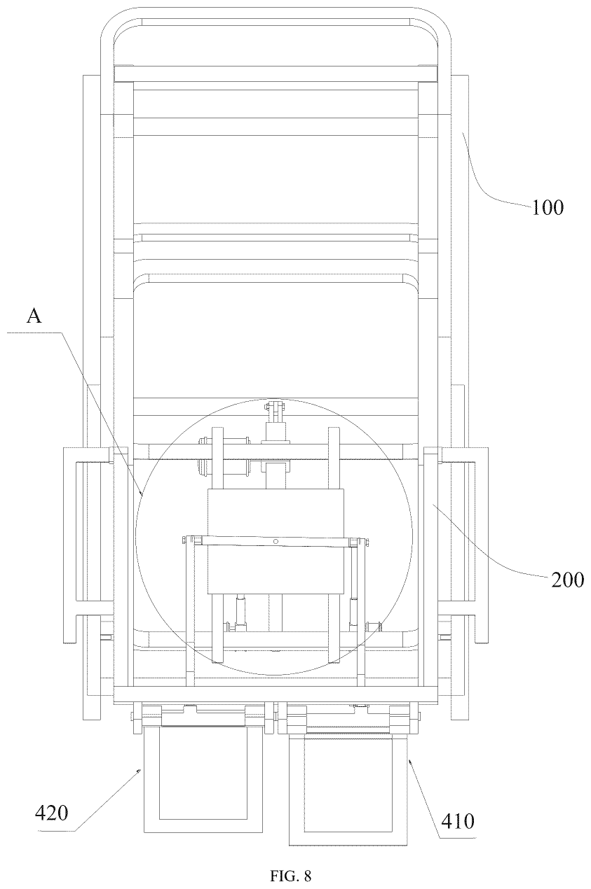

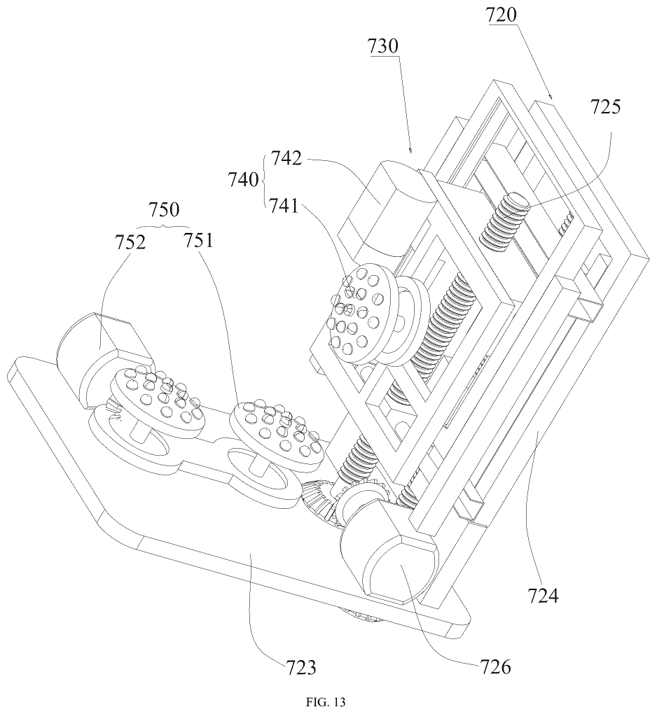

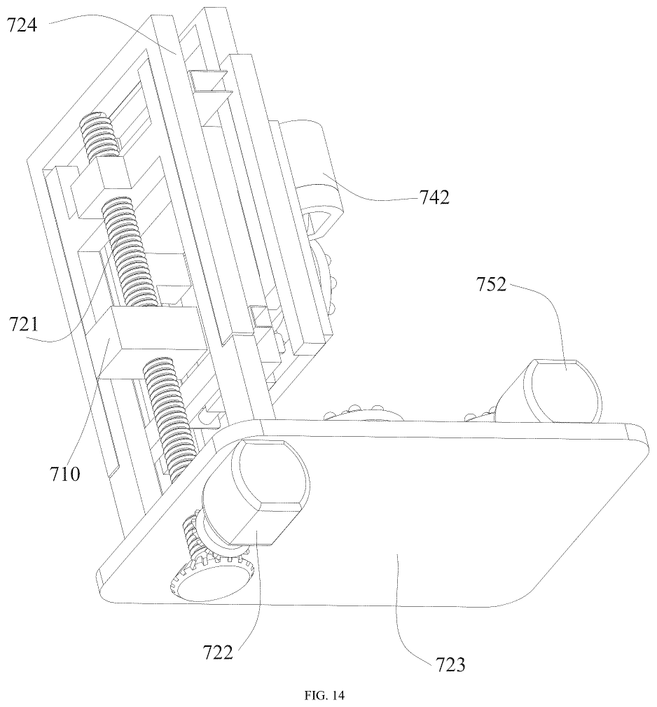

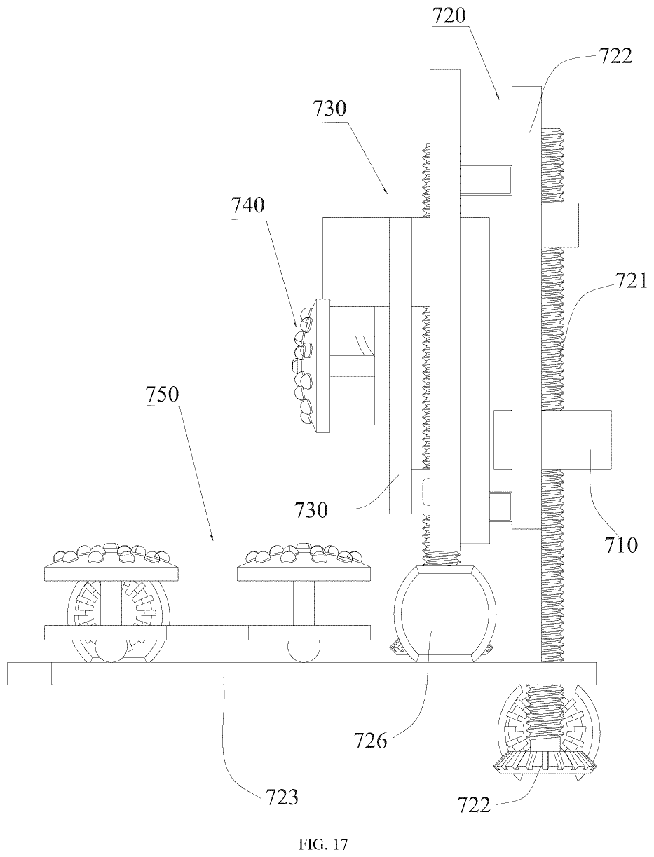

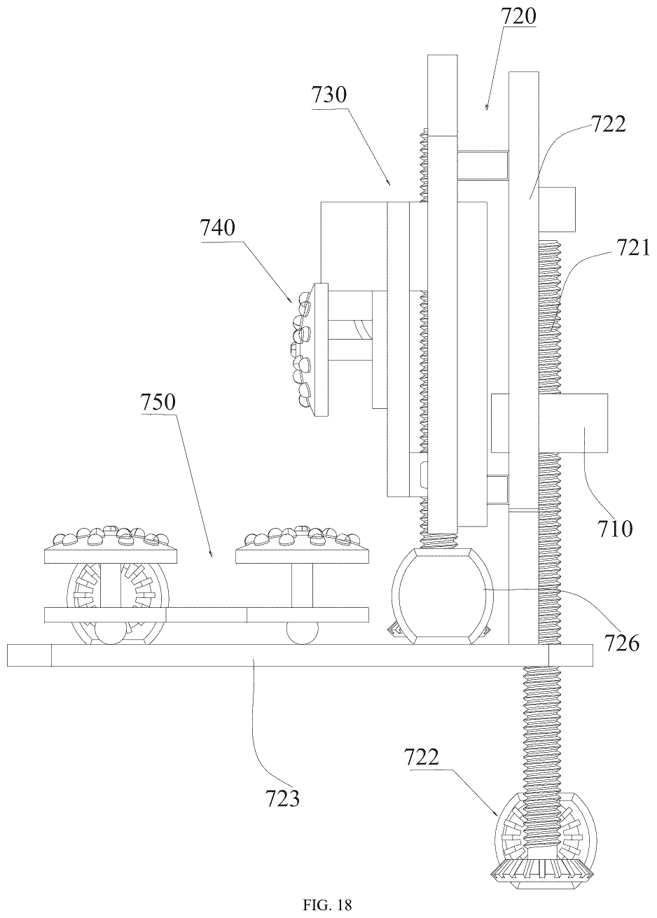

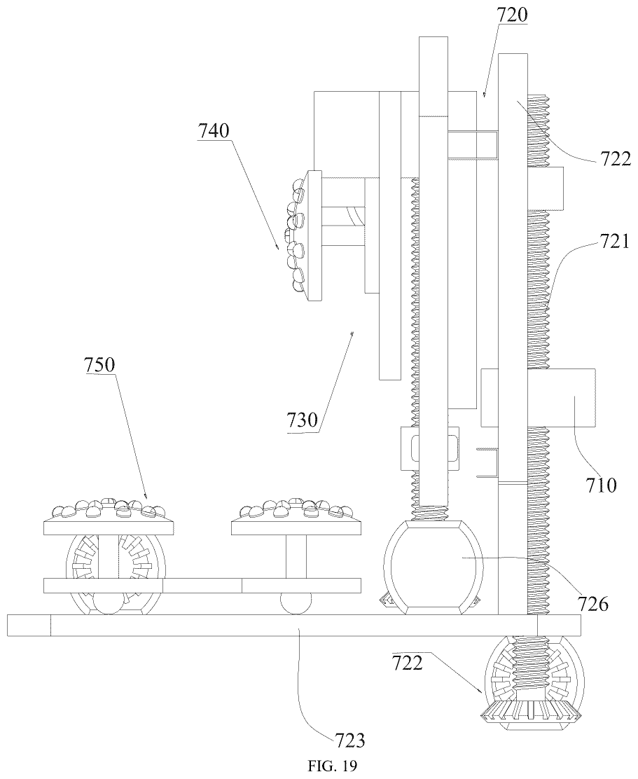

Referring to FIGS. 1 to 23, a massage apparatus includes: a backrest frame 100, a seat cushion frame 200, a supporting frame 300, a leg-foot assembly 400, and a driving mechanism 500.

The seat cushion frame 200 connected to a bottom of the backrest frame 100. The seat cushion frame 200 is rotatably connected to an upper portion of the supporting frame 300, the leg-foot assembly 400 including a first leg-foot frame 410 and a second leg-foot frame 420, the first leg-foot frame 410 and the second leg-foot frame 420 are rotatably connected to a front end of the seat cushion frame 200, respectively. The driving mechanism 500 is configured to drive the backrest frame 100 and the seat cushion frame 200 to rotate relative to the supporting frame 300, thereby switching the massage apparatus between a first massage state and a second massage state. The driving mechanism 500 further configured to drive the first leg-foot frame 410 and the second leg-foot frame 420 to rotate relative to the seat cushion frame 200.

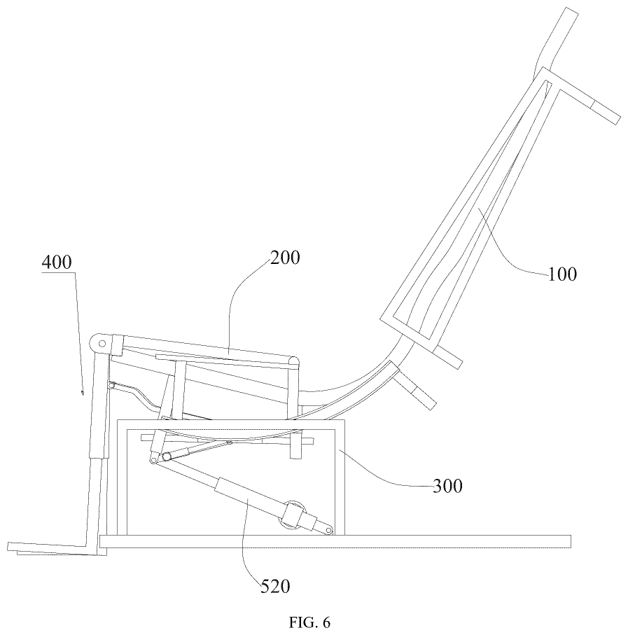

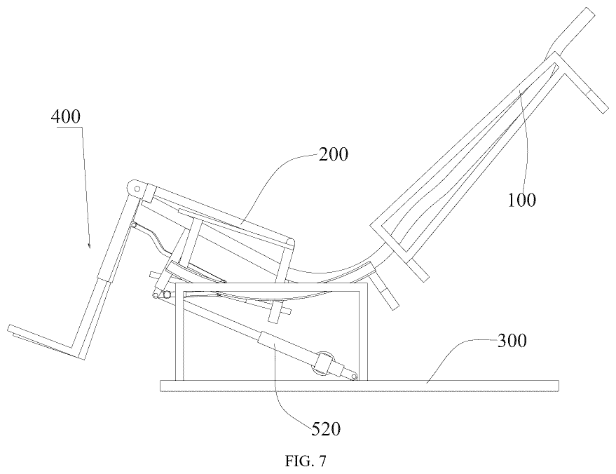

Through the arrangement of the above structures, a rear end of the seat cushion frame 200 is connected to a bottom end of the backrest frame 100, and the seat cushion frame 200 is rotatably connected to the supporting frame 300, such that the driving mechanism 500 can drive the seat cushion frame 200 to rotate relative to the supporting frame 300, thereby synchronously driving the backrest frame 100 to rotate and switching the massage apparatus between the first massage state and the second massage state. It should be noted that, as shown in FIG. 6, the first massage state corresponds to a user sitting on the massage apparatus, similar to a “sitting posture” state; as shown in FIG. 7, the second massage state corresponds to a user reclining on the massage apparatus, similar to a “reclining posture” state, the leg-foot assembly 400 includes the first leg-foot frame 410 and the second leg-foot frame 420 arranged side by side at the front end of the seat cushion frame 200. The driving mechanism 500 can independently or simultaneously drive the first leg-foot frame 410 and the second leg-foot frame 420 to lift or lower, enabling them to rotate relative to a front end of the seat cushion frame 200, thereby providing the user with a massage action similar to “pedaling a bicycle,” which can alleviate muscle fatigue in the user's legs.

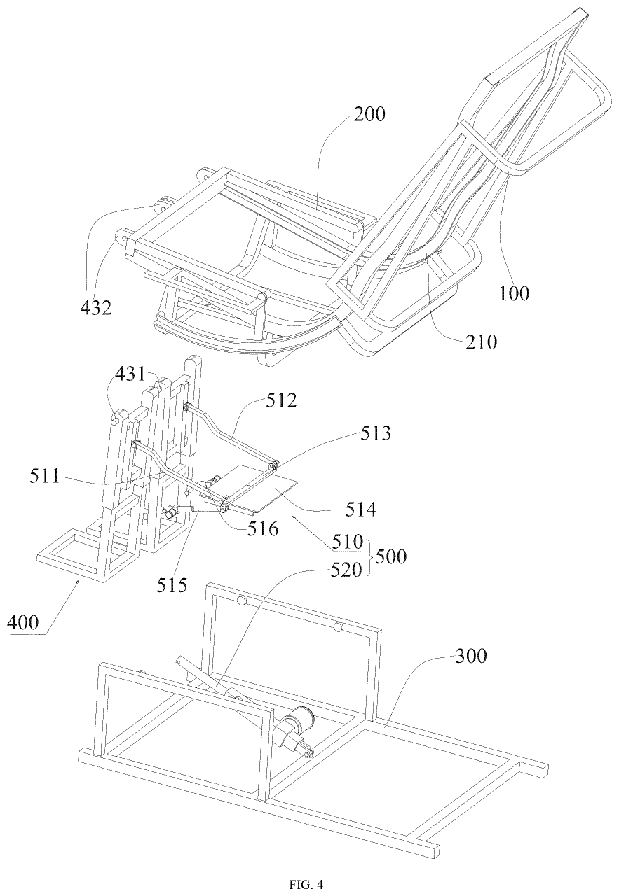

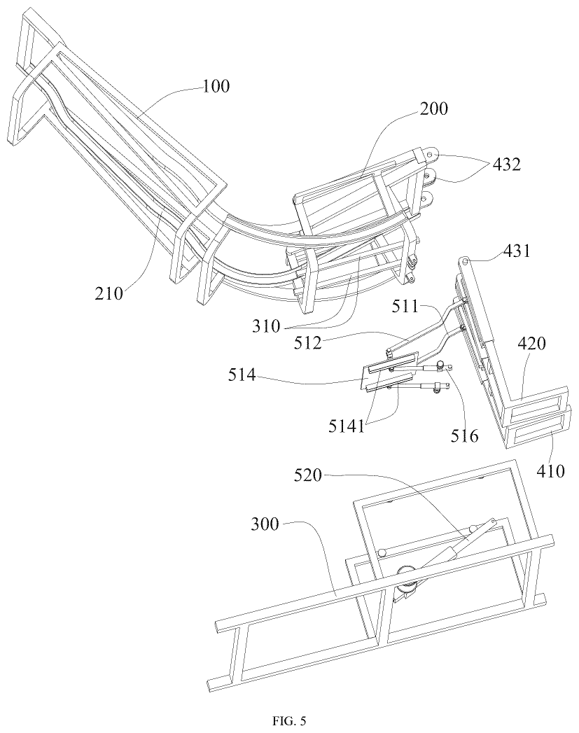

In this embodiment, the massage apparatus further includes a rotating shaft 431 and a rotating seat 432, the rotating seat 432 is connected to the seat cushion frame 200, one end of the rotating shaft 431 is connected to both sides of a top end of the first leg-foot frame 410 and both sides of a top end of the second leg-foot frame 420. The other end of the rotating shaft 431 is connected to the rotating seat 432. The driving mechanism 500 drives the rotating shaft 431 to rotate relative to the seat cushion frame 200 so as to cause the first leg-foot frame 410 and the second leg-foot frame 420 to rotate synchronously. Through the above arrangement, the rotating shaft 431 is fixed to both sides of the top ends of the first leg-foot frame 410 and the second leg-foot frame 420, respectively, and the rotating shaft 431 is rotatably connected to the rotating seat 432, providing multi-point support to ensure stability during rotation. It should be noted that, as shown in FIGS. 4 and 5, both sides of the top of the first leg-foot frame 410 and both sides of the top of the second leg-foot frame 420 correspond to respective rotating shafts 431 and rotating seats 432, enabling the first leg-foot frame 410 and the second leg-foot frame 420 to rotate relative to the seat cushion frame 200 independently. Preferably, a plurality of rotating seats 432 and a plurality of rotating shafts 431 are coaxially arranged.

In this embodiment, the driving mechanism 500 includes a leg driving assembly 510, an output end of the leg driving assembly 510 is connected to the first leg-foot frame 410 and the second leg-foot frame 420, respectively, and a connection end thereof is connected to the seat cushion frame 200. The leg driving assembly 510 drives the first leg-foot frame 410 and the second leg-foot frame 420 to rotate. Through the arrangement of the above structure, one connection end of the leg driving assembly 510 is connected to the seat cushion frame 200, and the output end is connected to the first leg-foot frame 410 and the second leg-foot frame 420, respectively, enabling the leg driving assembly 510 to independently drive the first leg-foot frame 410 and the second leg-foot frame 420 to lift or lower.

In this embodiment, the leg driving assembly 510 includes a first supporting rod 511, a second supporting rod 512, a swing rod 513, and a second driving motor 516. The swing rod 513 is swingable relative to the seat cushion frame 200, the first supporting rod 511 is connected between the first leg-foot frame 410 and one end of the swing rod 513, and the second supporting rod 512 is connected between the second leg-foot frame 420 and the other end of the swing rod 513; one end of the second driving motor 516 is connected to the seat cushion frame 200, and the other end is connected to the swing rod 513. The second driving motor 516 drives the swing rod 513 to swing, and the swing rod 513 drives the first supporting rod 511 and the second supporting rod 512 to move, thereby causing the first leg-foot frame 410 and the second leg-foot frame 420 to swing alternately. Through the arrangement of the above structure, the two ends of the swing rod 513 are connected to the first supporting rod 511 and the second supporting rod 512, respectively, forming a lever-like structure. Specifically, lifting of the first leg-foot frame 410 is necessarily accompanied by lowering of the second leg-foot frame 420, and vice versa. By driving the swing rod 513 with the second driving motor 516, the rotation of the swing rod 513 is converted into driving force for the first supporting rod 511 and the second supporting rod 512, thereby driving the lifting and lowering of the first leg-foot frame 410 and the second leg-foot frame 420.

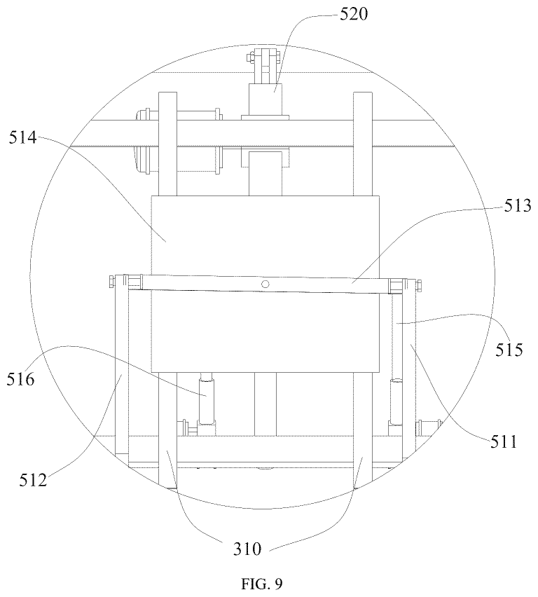

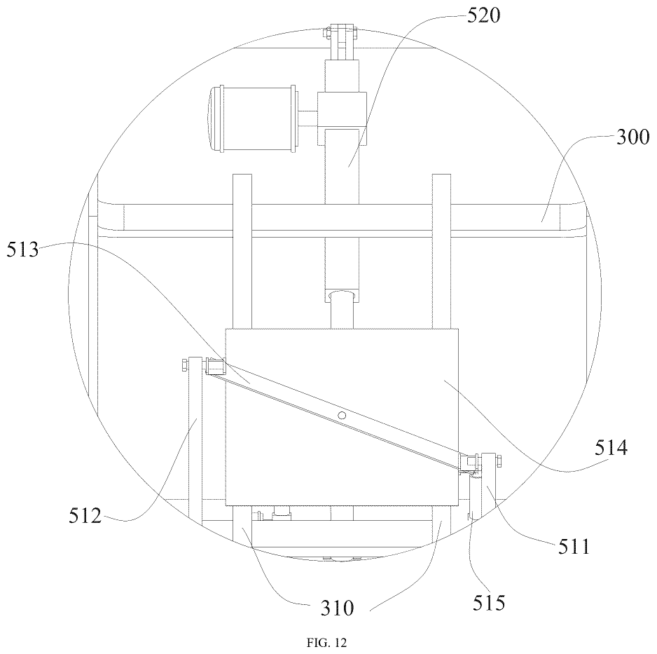

In this embodiment, the leg driving assembly 510 further includes a slide plate 514 and a first driving motor 515, the swing rod 513 is rotatably connected to the slide plate 514, a bottom portion of the seat cushion frame 200 is provided with opposing sliding rails 310, a bottom surface of the slide plate 514 is provided with opposing sliding grooves 5141 slidably engaged with the sliding rails 310, one end of the first driving motor 515 is connected to the seat cushion frame 200, and the other end is connected to the slide plate 514. The first driving motor 515 drives the slide plate 514 to slide back and forth along the sliding rails 310, thereby causing the swing rod 513 to move back and forth relative to the seat cushion frame 200. Through the arrangement of the above structure, the sliding grooves 5141 at the bottom of the slide plate 514 are engaged with the sliding rails 310, enabling the slide plate 514 to slide along a predetermined trajectory provided by the sliding rails 310 on the supporting frame 300. One end of the first driving motor 515 is connected to the seat cushion frame 200, and the other end is connected to the slide plate 514, for driving the slide plate 514 to slide back and forth along the sliding rails 310. It should be noted that, as shown in FIGS. 9 and 12, an intermediate region of the swing rod 513 is connected to the slide plate 514, i.e., a central region between connection points of the swing rod 513 with the first supporting rod 511 and the second supporting rod 512. Back-and-forth sliding of the slide plate 514 can drive swinging of the swing rod 513. In cooperation with driving by the second driving motor 516 and the first driving motor 515, different massage modes for the first leg-foot frame 410 and the second leg-foot frame 420 can be switched. When the slide plate 514 is positioned at the rear end or the front end of the supporting frame 300, the motion modes produced by the first leg-foot frame 410 and the second leg-foot frame 420 differ.

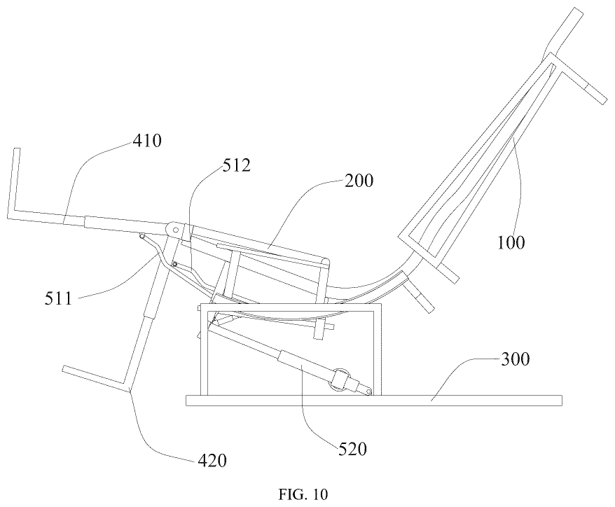

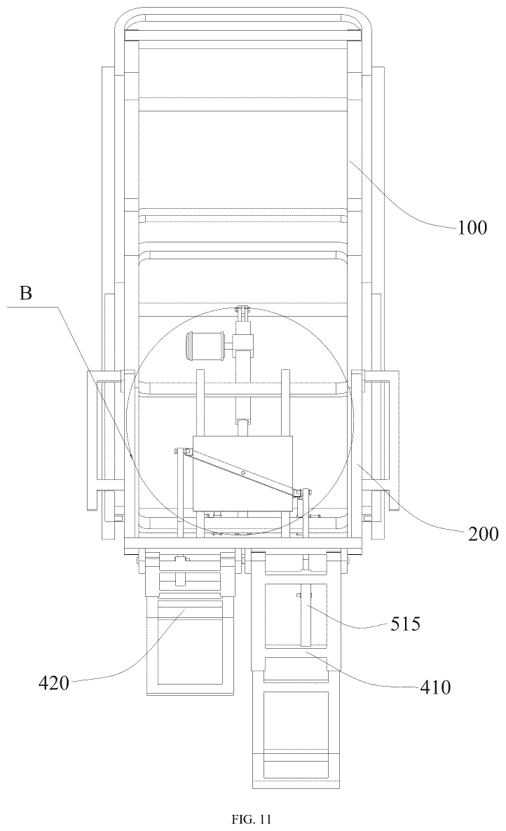

It should be noted that, as shown in FIGS. 4 and 5, the second driving motor 516 is connected to one end of the swing rod 513, and both the first driving motor 515 and the second driving motor 516 are connected to the front end of the seat cushion frame 200. Specifically, as shown in FIGS. 6, 8, and 9, both the first massage state and the second massage state illustrate the slide plate 514 positioned at the rear end of the supporting frame 300. When the first driving motor 515 drives the slide plate 514 to extend and slide to the rear end of the supporting frame 300, both the first driving motor 515 and the second driving motor 516 are in an extended state, and both the first leg-foot frame 410 and the second leg-foot frame 420 are in a lowered state. If the first driving motor 515 and the second driving motor 516 extend or contract synchronously, synchronous lifting and lowering actions of the first leg-foot frame 410 and the second leg-foot frame 420 can be achieved. As shown in FIGS. 10 and 11, when the first driving motor 515 starts contracting to drive the slide plate 514 to slide along the sliding rails 310 to the front end of the supporting frame 300, one end of the swing rod 513 is restricted by the second driving motor 516 (which is in an initial extended state at this time), causing swinging that lifts the second leg-foot frame 420 via the second supporting rod 512. When the second leg-foot frame 420 is lifted to a preset height, the operation of the first driving motor 515 is stopped; then, the second driving motor 516 is switched to a “contract-extend” operation mode, driving the swing rod 513 to swing, thereby causing alternating lifting and lowering of the first leg-foot frame 410 and the second leg-foot frame 420. When massage is completed, the second driving motor 516 is driven to extend, causing the first leg-foot frame 410 to lower, and then the operation of the second driving motor 516 is stopped; subsequently, the first driving motor 515 is started to extend, driving the slide plate 514 to slide rearward to the rear end of the supporting frame 300, at which point both the first leg-foot frame 410 and the second leg-foot frame 420 are in the lowered state (i.e., returned to the initial state).

In this embodiment, the driving mechanism 500 further includes a main driving assembly 520, one end of the main driving assembly 520 is connected to the seat cushion frame 200, and the other end is connected to the supporting frame 300. The main driving assembly 520 drives the seat cushion frame 200 to rotate relative to the supporting frame 300, thereby synchronously driving the backrest frame 100 to rotate and switching the massage apparatus between the first massage state and the second massage state. Through the arrangement of the above structure, the main driving assembly 520 enables overall adjustment of the seat cushion frame 200 and the backrest frame 100. The initial state is the first massage state (i.e., sitting posture state). When the main driving assembly 520 drives the seat cushion frame 200 and the backrest frame 100 to rotate clockwise relative to the supporting frame 300, the massage state switches to the second massage state (i.e., reclining posture state). Meanwhile, the main driving assembly 520 can operate independently of or in coordination with the leg driving assembly 510. It should be noted that a bottom side end of the seat cushion frame 200 is slidably connected to an upper side end of the supporting frame 300.

In this embodiment, a track 210 is further included, the track 210 is located on the backrest frame 100 and the seat cushion frame 200 for installing a back massage assembly. With the arrangement of the above structure, the track 210 is fixed on the backrest frame 100 and the seat cushion frame 200. The track 210 provides a precise massage trajectory for the massage modes of the backrest frame 100 and the seat cushion frame 200, enabling the back massage assembly on the backrest frame 100 and the seat cushion frame 200 to move stably along the trajectory of the track 210, thereby ensuring that the movement of the back massage assembly can cover most areas from the user's shoulder and neck to the buttocks. Preferably, the track 210 is generally an L-shaped track, with the L-shaped track spanning and fixed between the backrest frame 100 and the seat cushion frame 200. Optionally, the track 210 serves as the main body, while the backrest frame 100 and the seat cushion frame 200 are correspondingly fixed on the backrest section and the seat cushion section of the track 210.

In this embodiment, both the first leg-foot frame 410 and the second leg-foot frame 420 include a guiding rail bracket 441 and a moving bracket 442, the moving bracket 442 is slidably inserted into the guiding rail bracket 441. With the arrangement of the above structure, the moving bracket 442 is directly slidably inserted into the guiding rail bracket 441, enabling the moving bracket 442 to perform stable linear reciprocating motion along the guiding rail bracket 441. Preferably, both the guiding rail bracket 441 and the moving bracket 442 are hollow tubular structures, and the dimensions of the moving bracket 442 match those of the guiding rail bracket 441, allowing the moving bracket 442 to be flexibly inserted.

In this embodiment, both the first leg-foot frame 410 and the second leg-foot frame 420 are provided with a leg-foot massage mechanism 700, the leg-foot massage mechanism 700 is connected to the guiding rail bracket 441. With the arrangement of the above structure, the leg-foot massage mechanism 700 serves as an integral motion unit connected to the guiding rail bracket 441.

In this embodiment, the leg-foot massage mechanism 700 includes a first nut 710 and a first lifting frame 720, the first nut 710 is connected to the guiding rail bracket 441, and the first lifting frame 720 is connected to the moving bracket 442, so that the first lifting frame 720 can slide up and down relative to the first nut 710. With the arrangement of the above structure, the first nut 710 is fixed on the guiding rail bracket 441, while the first lifting frame 720 is connected to the moving bracket 442. Since the moving bracket 442 can slide up and down along the guiding rail bracket 441, this enables the first lifting frame 720 to also move up and down relative to the guiding rail bracket 441. The first lifting frame 720 serves as a sliding lifting unit between the leg-foot massage mechanism 700 and the guiding rail bracket 441. According to the user's needs, the entire leg-foot massage mechanism 700 can be adjusted up and down along the guiding rail bracket 441.

In this embodiment, the first lifting frame 720 is connected with a first lead screw 721 and a first leg motor 722 that drives the first lead screw 721 to rotate, the first lead screw 721 is engaged with the first nut 710, and the first leg motor 722 drives the first lead screw 721 to rotate, so that the first nut 710 drives the moving bracket 442 to slide up and down along the guiding rail bracket 441. With the arrangement of the above structure, the first nut 710 and the first lead screw 721 form a lead screw-nut pair, with the threaded section of the first lead screw 721 matching the threaded section of the first nut 710. The lead screw-nut pair can convert the rotational motion of the first leg motor 722 on the first lead screw 721 into linear motion. When the first leg motor 722 is activated, it drives the first lead screw 721 to rotate about its own axis. With the first nut 710 fixed on the guiding rail bracket 441, under the thread constraint of the first nut 710, the first lead screw 721 generates linear motion along its axial direction. Since the first lead screw 721 is mounted on the first lifting frame 720, the axial linear motion of the first lead screw 721 is directly transmitted to the entire first lifting frame 720, thereby converting it into up-and-down sliding of the first lifting frame 720 relative to the guiding rail bracket 441. It should be noted that the axis of the first nut 710 coincides with the axis of the first lead screw 721.

In this embodiment, the first lifting frame 720 further includes a base 723 connected to the first lead screw 721, the base 723 is provided with a leg massage assembly 740. With the arrangement of the above structure, the first lifting frame 720 includes the base 723 connected to the first lead screw 721, and a foot massage assembly 750 is fixed on the base 723, so that the foot massage assembly 750 can rise and descend synchronously with the first lifting frame 720 along the guiding rail bracket 441. Regardless of whether the user is in the first massage state or the second massage state, and regardless of whether the first leg-foot frame 410 and the second leg-foot frame 420 are in a raised or lowered position, the leg-foot massage mechanism 700 can slide up and down along the guiding rail bracket 441 via the first lifting frame 720 to meet the user's diverse needs. It should be noted that the foot massage assembly 750 includes a foot massage head 751 and a foot massage motor 752, the foot massage motor 752 drives the foot massage head 751 to rotate, relaxing the user's foot muscles.

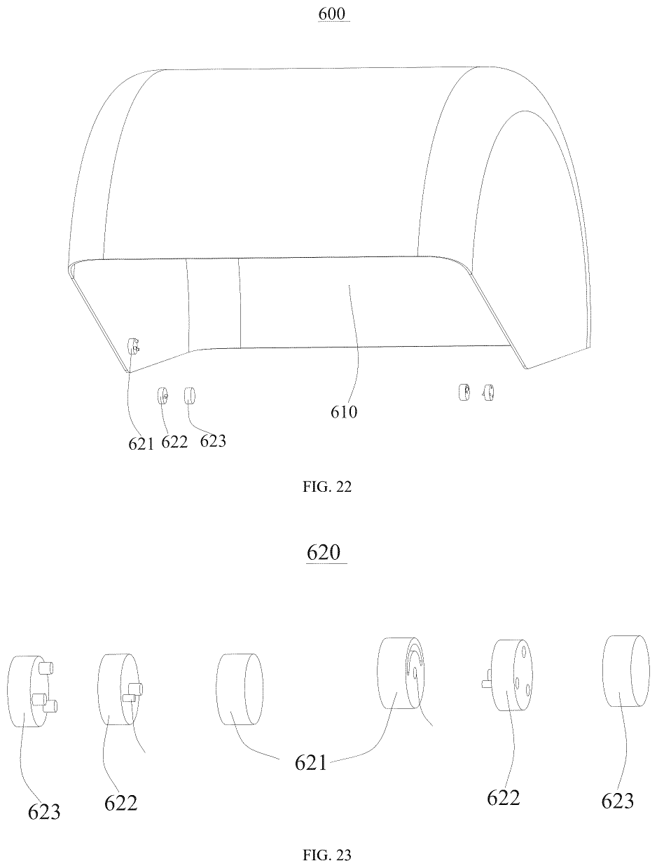

In this embodiment, the leg-foot massage mechanism 700 further includes a side stand 724, a leg massage assembly 740, and a second lifting frame 730, the second lifting frame 730 is connected to the side stand 724, and the leg massage assembly 740 is connected to the second lifting frame 730. With the arrangement of the above structure, the leg-foot massage mechanism 700 further includes the second lifting frame 730. The side stand 724 undertakes the sliding function for the entire second lifting frame 730, while the second lifting frame 730 is responsible for the up-and-down sliding of the leg massage assembly 740, distinguishing it from the overall up-and-down sliding of the base 723 and the side stand 724 carried by the first lifting frame 720. The first lifting frame 720 drives the foot massage assembly 740 on its base 723 and the second lifting frame 730 on the side stand 724 to achieve overall height adjustment, adapting to differences in leg lengths among different users. The second lifting frame 730 can independently drive the leg massage assembly 740 to slide up and down relative to the side stand 724 based on the positioning of the first lifting frame 720, thereby achieving massage on the user's leg position within a small range. It should be noted that, as shown in FIGS. 22 and 23, the leg massage assembly 740 includes a leg massage head 741 and a leg massage motor 742, the leg massage motor 742 drives the leg massage head 741 to rotate, relaxing the user's leg muscles.

In this embodiment, the second lifting frame 730 is provided with a second nut 731 connected to the leg massage assembly 740, the side stand 724 is connected with a second lead screw 725 and a second leg motor 726 that drives the second lead screw 725 to rotate. The second lead screw 725 is engaged with the second nut 731, and the second leg motor 726 drives the second nut 731 to rotate, so that the second lead screw 725 drives the second lifting frame 730 to slide up and down along the side stand 724, thereby causing the leg massage assembly 740 to slide up and down along the side stand 724. With the arrangement of the above structure, the second lead screw 725 and the second nut 731 also form a complete lead screw-nut pair, which converts the rotational motion of the second leg motor 726 driving the second lead screw 725 into linear motion of the second lead screw 725 relative to its own axis. When the second leg motor 726 is activated, it drives the second lead screw 725 to rotate about its own axis. With the second nut 731 fixed on the second lifting frame 730, under the thread constraint of the second nut 731, the second lead screw 725 generates linear motion along its axial direction. Since the second lead screw 725 is mounted on the first lifting frame 720, the axial linear motion of the second lead screw 725 is directly transmitted to the entire second lifting frame 730. As the leg massage assembly 740 is connected to the second nut 731, and the second nut 731 is slidably connected to the first lifting frame 720, the up-and-down sliding of the second nut 731 drives the leg massage assembly 740 to slide up and down synchronously.

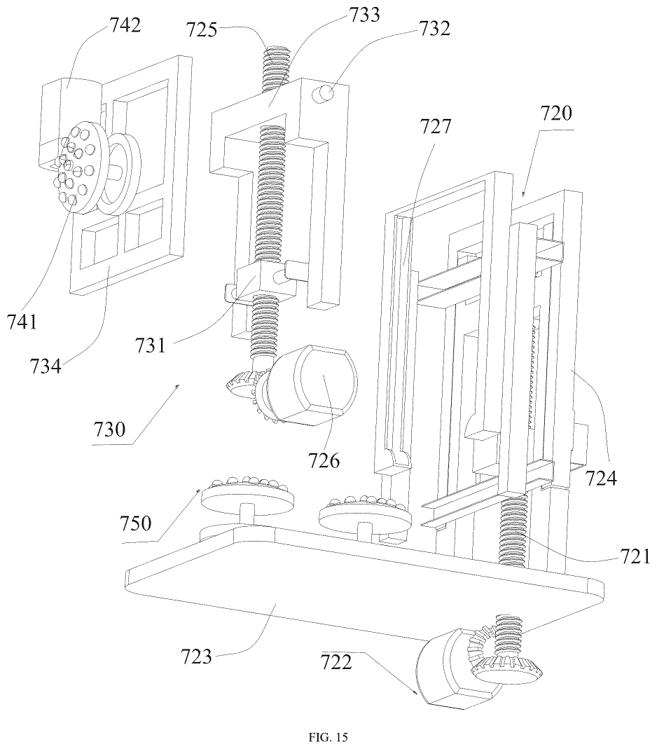

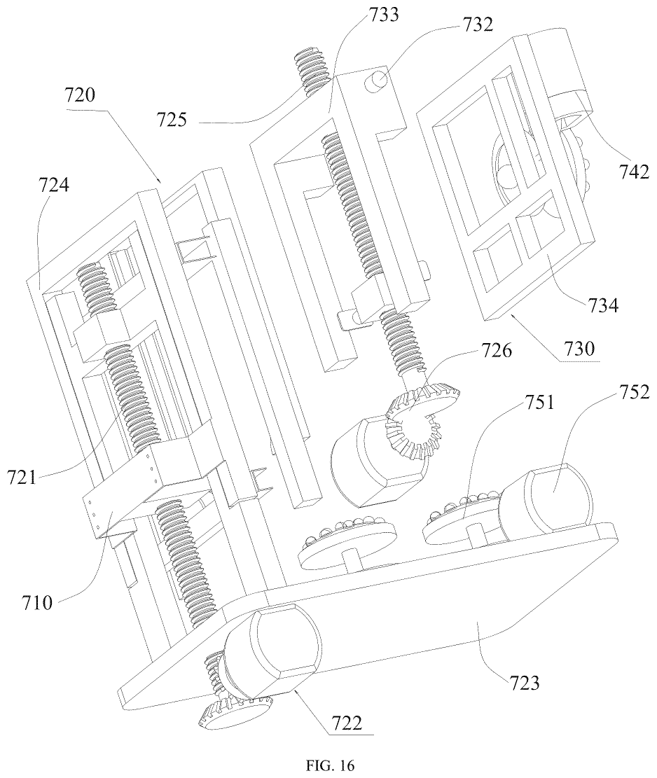

In this embodiment, the second lifting frame 730 is further provided with a guiding rod 732, the first lifting frame 720 is provided with a guiding slot 727, the guiding rod 732 is slidably inserted into the guiding slot 727, and the second leg motor 726 drives the second nut 731 to rotate, so that the second lead screw 725 drives the second lifting frame 730 to slide up and down along the side stand 724, thereby driving the guiding rod 732 to slide up and down within the guiding slot 727. With the arrangement of the above structure, the second lifting frame 730 is provided with the guiding rod 732, and the first lifting frame 720 is provided with the guiding slot 727. The guiding rod 732 is slidably inserted into the guiding slot 727. When the second nut 731 moves up and down along the second lead screw 725, it drives the guiding rod 732 to slide up and down within the guiding slot 727. The provision of the guiding slot 727 and the guiding rod 732 offers a certain guiding and sliding function for the up-and-down movement of the second lifting frame 730. Preferably, as shown in FIGS. 15 and 16, the second lifting frame 730 includes a lifting seat 733 and a mounting frame 734, the lifting seat 733 is fixedly connected to the mounting frame 734 for synchronous lifting and lowering. The guiding rod 732 is located at the upper end of the lifting seat 733, and the second nut 731 is connected to the lower end of the lifting seat 733. The leg massage assembly 740 is connected to the mounting frame 734, which serves as a bearing structure connecting the leg massage assembly 740 to the lifting seat 733. This design divides the second lifting frame 730 into two structural parts: the mounting frame 734 facilitates the installation of the leg massage assembly 740, while the lifting seat 733 facilitates driving the entire second lifting frame 730 to rise and descend along the first lifting frame 720.

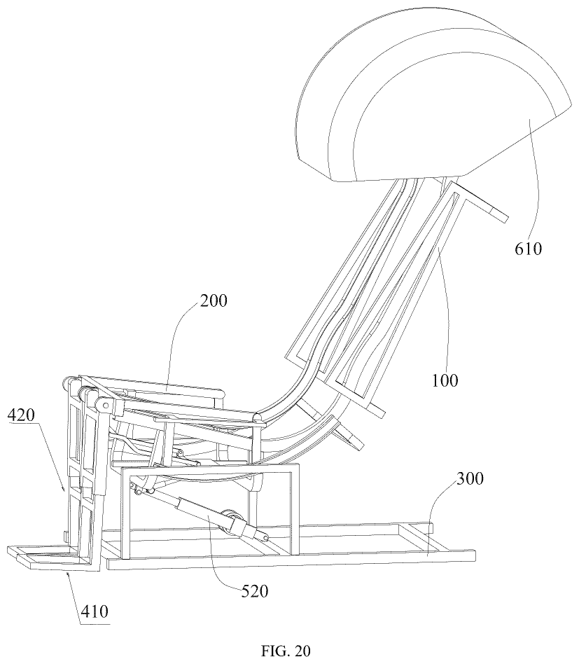

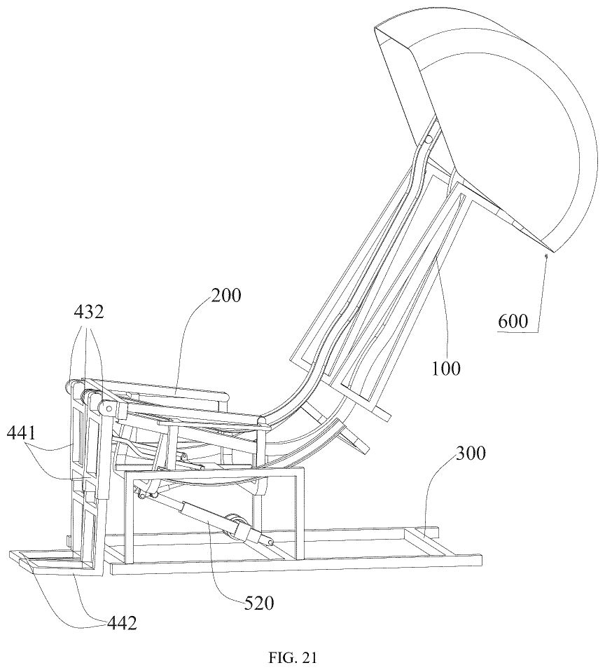

In this embodiment, a light-shielding assembly 600 is further included, the light-shielding assembly 600 is connected to the backrest frame 100 for selectively shielding light for the user of the massage apparatus. With the arrangement of the above structure, as shown in FIG. 20, the first light-shielding state does not block light for the user; as shown in FIG. 21, the second light-shielding state blocks light for the user. The light-shielding assembly 600 allows the user of the massage apparatus to selectively block light, i.e., the light-shielding assembly 600 switches between the first light-shielding state and the second light-shielding state. When ambient light is strong or the user needs to rest with eyes closed, the light-shielding assembly 600 can fully perform its light-shielding function.

In this embodiment, the light-shielding assembly 600 includes a light shield 610 and a mounting component 620, the mounting component 620 is connected to the backrest frame 100, and the light shield 610 is connected to the mounting component 620. With the arrangement of the above structure, the light-shielding assembly 600 further includes the mounting component 620 and the light shield 610, ensuring the connection stability of the light shield 610.

In this embodiment, the mounting component 620 includes a first mounting portion 621 and a second mounting portion 622. The first mounting portion 621 is connected to the upper end of the backrest frame 100, the light shield 610 is connected to the second mounting portion 622. And the second mounting portion 622 is rotatably connected to the first mounting portion 621. So that the light shield 610 can rotate relative to the backrest frame 100. With the arrangement of the above structure, the first mounting portion 621 is fixedly connected to the upper end of the backrest frame 100, while the second mounting portion 622 is rotatably connected to the first mounting portion 621, allowing the user to adjust the direction of the light shield 610 according to their needs. When light shielding is required, the light shield 610 is rotated to the desired angle; when not required, the light shield 610 is rotated to the rear of the backrest frame 100, thereby avoiding obstruction by the light shield 610. Preferably, the first mounting portion 621 is provided with a rotation slot and a mounting hole. Correspondingly, the corresponding end of the second mounting portion 622 is provided with a rotation post and a mounting post. The rotation post is slidably inserted into the rotation slot, and the mounting post is inserted into the mounting hole to connect and fix the second mounting portion 622 and the first mounting portion 621.

In this embodiment, the mounting component 620 further includes a third mounting portion 623, one end of the third mounting portion 623 is connected to the light shield 610, and the other end is detachably connected to the second mounting portion 622, so that the light shield 610 can selectively shield light for the user of the massage apparatus. With the arrangement of the above structure, the provision of the third mounting portion 623 allows the light shield 610 to be detached and installed according to the user's needs. When needed, the light shield 610 is installed onto the second mounting portion 622 via the third mounting portion 623; when light shielding is not required, the light shield 610 can be easily removed, which also provides great convenience for later maintenance and cleaning of the light shield 610. Preferably, the light shield 610 is connected to the third mounting portion 623; the second mounting portion 622 and the third mounting portion 623 have corresponding magnetic forces and are magnetically attracted to each other. One end of the third mounting portion 623 is provided with a magnetic attraction post, and the corresponding end of the second mounting portion 622 is provided with a magnetic attraction hole. The magnetic attraction post is inserted into the magnetic attraction hole, and the provision of the magnetic attraction post and hole serves for guidance and connection, guiding the third mounting portion 623 to approach and magnetically attract to the second mounting portion 622.

In this embodiment, the light shield 610 is made of a rigid material. With the arrangement of the above structure, using a rigid material to fabricate the light shield 610 enables it to maintain its predetermined shape and structural stability, preventing deformation, collapse, or distortion due to force, heat, or long-term use during the operation or assembly of the massage apparatus, thereby extending the service life of the light shield 610.

The above describes one or more embodiments provided in conjunction with specific content, and it is not deemed that the specific implementation of the present disclosure is limited to these descriptions. Any approximations or similarities to the methods and structures of the present disclosure, or any technical deductions or substitutions made under the premise of the concept of the present disclosure, shall be considered within the scope of protection of the present disclosure.

What is claimed is:

1. A massage apparatus, comprising:
a backrest frame; and
a seat cushion frame connected to a bottom of the backrest frame;
a supporting frame, wherein the seat cushion frame is rotatably connected to an upper portion of the supporting frame;
a leg-foot assembly comprises a first leg-foot frame and a second leg-foot frame, wherein the first leg-foot frame and the second leg-foot frame are each rotatably connected to a front end of the seat cushion frame; and
a driving mechanism configured to drive the backrest frame and the seat cushion frame to rotate relative to the supporting frame so as to switch the massage apparatus between a first massage state and a second massage state;
wherein the driving mechanism is further configured to drive the first leg-foot frame and the second leg-foot frame to rotate relative to the seat cushion frame.

2. The massage apparatus according to claim 1, further comprising a rotating shaft and a rotating seat, wherein the rotating seat is connected to the seat cushion frame; one end of the rotating shaft is connected to both sides of a top end of the first leg-foot frame and both sides of a top end of the second leg-foot frame, and the other end of the rotating shaft is connected to the rotating seat, wherein the driving mechanism is configured to drive the rotating shaft to rotate relative to the seat cushion frame, thereby causing the first leg-foot frame and the second leg-foot frame to rotate synchronously.

3. The massage apparatus according to claim 1, wherein the driving mechanism comprises a leg driving assembly, an output end of the leg driving assembly is connected to the first leg-foot frame and the second leg-foot frame, and a connection end of the leg driving assembly is connected to the seat cushion frame, wherein the leg driving assembly is configured to drive the first leg-foot frame and the second leg-foot frame to rotate.

4. The massage apparatus according to claim 3, wherein the leg driving assembly comprises a first supporting rod, a second supporting rod, a swing rod, and a second driving motor, wherein the swing rod is configured to swing relative to the seat cushion frame;
the first supporting rod is connected between the first leg-foot frame and one end of the swing rod, and the second supporting rod is connected between the second leg-foot frame and the other end of the swing rod;
one end of the second driving motor is connected to the seat cushion frame and the other end is connected to the swing rod, wherein the second driving motor is configured to drive the swing rod to swing, and the swing rod drives the first supporting rod and the second supporting rod to move so as to cause the first leg-foot frame and the second leg-foot frame to swing alternately.

5. The massage apparatus according to claim 4, wherein the leg driving assembly further comprises a sliding plate and a first driving motor, the swing rod is rotatably connected to the sliding plate, a bottom of the seat cushion frame is provided with opposing sliding rails, a bottom surface of the sliding plate is defined with opposing sliding grooves, the sliding grooves are slidably engaged with the sliding rails, one end of the first driving motor is connected to the seat cushion frame and the other end is connected to the sliding plate, wherein the first driving motor is configured to drive the sliding plate to slide back and forth along the sliding rails so as to cause the swing rod to move back and forth relative to the seat cushion frame.

6. The massage apparatus according to claim 1, wherein the driving mechanism further comprises a main driving assembly, one end of the main driving assembly is connected to the seat cushion frame and the other end is connected to the supporting frame, wherein the main driving assembly is configured to drive the seat cushion frame to rotate relative to the supporting frame, thereby driving the backrest frame to rotate synchronously so as to switch the massage apparatus between the first massage state and the second massage state.

7. The massage apparatus according to claim 1, further comprising a track disposed on the backrest frame and the seat cushion frame for mounting a back massage assembly.

8. The massage apparatus according to claim 1, wherein each of the first leg-foot frame and the second leg-foot frame comprises a guiding rail bracket and a moving bracket, wherein the moving bracket is slidably engaged with the guiding rail bracket.

9. The massage apparatus according to claim, 8 wherein each of the first leg-foot frame and the second leg-foot frame is provided with a leg and foot massage mechanism, the leg and foot massage mechanism is connected to the guiding rail bracket.

10. The massage apparatus according to claim 9, wherein the leg and foot massage mechanism comprises a first nut and a first lifting frame, the first nut is connected to the guiding rail bracket, and the first lifting frame is connected to the moving bracket, such that the first lifting frame is slidable up and down relative to the first nut.

11. The massage apparatus according to claim 10, wherein the first lifting frame is connected to a first lead screw and a first leg motor that drives the first lead screw to rotate, the first lead screw is engaged with the first nut; and the first leg motor is configured for driving the first lead screw to rotate, thereby causing the first nut to drive the moving bracket to slide up and down along the guiding rail bracket.

12. The massage apparatus according to claim 11, wherein the first lifting frame further comprises a base connected to the first lead screw, and the base is provided with a foot massage assembly.

13. The massage apparatus according to claim 11, wherein the leg and foot massage mechanism further comprises a side stand, a leg massage assembly, and a second lifting frame, the second lifting frame is connected to the side stand, and the leg massage assembly is connected to the second lifting frame.

14. The massage apparatus according to claim 13, wherein the second lifting frame is provided with a second nut connected to the leg massage assembly, the side stand is connected to a second lead screw and a second leg motor that drives the second lead screw to rotate, the second lead screw is engaged with the second nut, and the second leg motor driving the second nut to rotate, thereby causing the second lead screw to drive the second lifting frame to slide up and down along the side stand.

15. The massage apparatus according to claim 14, wherein the second lifting frame is further provided with a guiding rod, the first lifting frame is provided with a guiding slot, the guiding rod being slidably inserted into the guiding slot, and the second leg motor driving the second nut to rotate, thereby causing the second lead screw to drive the second lifting frame to slide up and down along the side stand, and thus driving the guiding rod to slide up and down within the guiding slot.

16. The massage apparatus according to claim 1, further comprising a light-shielding assembly, the light-shielding assembly is connected to the backrest frame for selectively shielding light from a user of the massage apparatus.

17. The massage apparatus according to claim 16, wherein the light-shielding assembly comprises a light shield and a mounting component, the mounting component is connected to the backrest frame, and the light shield is connected to the mounting component.

18. The massage apparatus according to claim 17, wherein the mounting component comprises a first mounting portion and a second mounting portion, the first mounting portion is connected to an upper end of the backrest frame, the light shield is connected to the second mounting portion, and the second mounting portion is rotatably connected to the first mounting portion, such that the light shield is rotatable relative to the backrest frame.

19. The massage apparatus according to claim 18, wherein the mounting component further comprises a third mounting portion, one end of the third mounting portion is connected to the light shield and the other end is detachably connected to the second mounting portion, such that the light shield can selectively shield light from the user of the massage apparatus.

20. The massage apparatus according to claim 17, wherein the light shield is made of a rigid material.
